(19) United States
(12) Patent Application Publication
(10) Pub. No.: US 2026/0184377 A1
(43) Pub. Date: Jul. 2, 2026

(54) VEHICLE AND ROOF

(71) Applicant: KAWASAKI MOTORS, LTD., Hyogo (JP)

(72) Inventors: John RAMEY, Lincoln, NE (US); Justin OLSON, Lincoln, NE (US)

(73) Assignee: KAWASAKI MOTORS, LTD., Hyogo (JP)

(21) Appl. No.: 19/290,362

(22) Filed: Aug. 5, 2025

Related U.S. Application Data
(60) Provisional application No. 63/739,285, filed on Dec. 27, 2024.

(51) Int. Cl. B62D 25/06; B60R 11/00; B60R 11/02; B60R 11/04; B60R 13/08; B60R 16/02

(52) U.S. Cl. CPC B62D 25/06; B60R 11/0217; B60R 11/0229; B60R 11/04; B60R 13/0815; B60R 16/0207; B60R 2011/0022

(57) ABSTRACT

A utility vehicle includes a roof; a hollow pillar extending in a top-bottom direction and supporting the roof; a lower electric component located below the pillar; an upper electric component located above the pillar; and a harness electrically connecting the lower electric component and the upper electric component to each other and at least partially located in a hollow space inside the pillar.

### CROSS-REFERENCE TO RELATED APPLICATION

This application claims priority to U.S. Provisional Application No. 63/739,285 filed on Dec. 27, 2024, the entire disclosure of which is incorporated herein by reference.

### FIELD

The technique disclosed here relates to a vehicle and a roof.

### BACKGROUND

U.S. Pat. No. 9,091,390 discloses a vehicle in which a loudspeaker is attached to a frame.

### SUMMARY

A vehicle disclosed here includes: a roof; a hollow pillar extending in a top-bottom direction and supporting the roof; a lower electric component located below the pillar; an upper electric component located above the pillar; and a harness electrically connecting the lower electric component and the upper electric component to each other and at least partially located in a hollow space inside the pillar.

A roof disclosed here includes: a roof body; and a pillar attachment portion and a loudspeaker attachment located on an identical surface of the roof body, and the loudspeaker attachment portion is located near the pillar attachment portion.

A roof disclosed here includes: a roof body; and a pillar attachment portion and a camera attachment portion located on an identical surface of the roof body, and the camera attachment portion is located rearward of the pillar attachment portion.

### BRIEF DESCRIPTION OF THE DRAWINGS

FIG. 1 is a left side view of a utility vehicle according to an embodiment.

FIG. 2 is a schematic cross-sectional view of a left front pillar.

FIG. 3 is a perspective view of a roof, as viewed from the front and below.

FIG. 4 is a bottom view of the roof, as viewed from below.

FIG. 5 is a perspective view illustrating a front pillar attachment portion, a front loudspeaker attachment portion, and a first restriction portion, as viewed from below.

FIG. 6 is a perspective view of a camera attachment portion, as viewed from below.

FIG. 7 is a perspective view of a front loudspeaker attached to the roof, as viewed from below.

FIG. 8 is a perspective view of a camera attached to the roof, as viewed from below.

FIG. 9 is a perspective view of a state where left front pillar is attached to a body frame, as viewed from the front and above.

FIG. 10 is a schematic cross-sectional view of a restrictor that restricts movement of a harness.

FIG. 11 is a cross-sectional view including a front loudspeaker and a roof of a utility vehicle according to a first variation.

FIG. 12 is a perspective view of a cover.

FIG. 13 is a cross-sectional view illustrating a front loudspeaker according to another variation.

### DESCRIPTION OF EMBODIMENTS

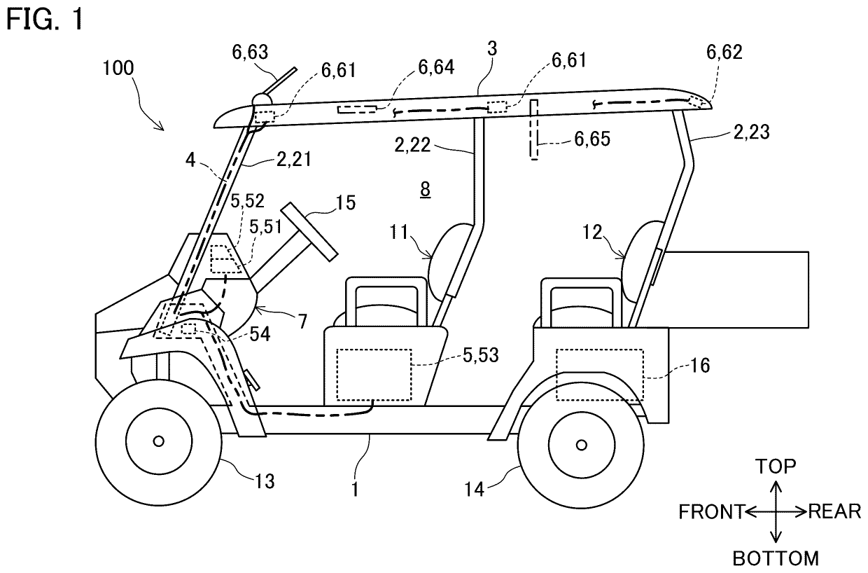

An exemplary embodiment will be described in detail hereinafter with reference to the drawings. FIG. 1 is a left side view of a utility vehicle 100. Hereinafter, the utility vehicle 100 will also be referred to simply as a “vehicle 100.”

The vehicle 100 corresponds to one example of a vehicle disclosed here. The vehicle 100 is a vehicle intended to travel at low speed in a limited area. Examples of the limited area include a limited community area, a private road, and a private property (e.g., a golf course, a park, etc.). The limited community area refers to an area available for use by local residents. The community area is, for example, an area including houses and public facilities (e.g., schools, hospitals, etc.), and is an area where the vehicle 100 not intended to travel on a public road is permitted to travel at low speed. The low speed refers to a speed up 20 mph to 30 mph, for example. The vehicle 100 may travel at a speed of 20 mph or less or 30 mph or more. The vehicle 100 includes, for example, a personal transport vehicle (PTV). The PTV includes a golf cart. The vehicle 100 may be other golf carts such as a low speed vehicle (LSV).

In this disclosure, components of the vehicle 100 will be described based on directions of the vehicle 100. Specifically, “front” refers to the front of the vehicle 100 in the vehicle front-rear directions, and “rear” refers to the rear of the vehicle 100 in the vehicle front-rear directions. “Left” refers to the left of the vehicle 100 when seeing forward, and “right” refers to the right of the vehicle 100 when seeing forward. The “vehicle width direction” refers to the vehicle width direction of the vehicle 100, in other words, means the left-right direction of the vehicle 100 and will be sometimes referred to as a “left-right direction.” An “inner side in the vehicle width direction” refers to a cabin side in the vehicle width direction, and an “outer side in the vehicle width direction” refers to a vehicle outer side in the vehicle width direction. The expression “a member extends or expands in a direction” herein includes not only a case where the member extends or expands strictly in parallel with the direction” but also a case where the member extends or expands generally in the direction.”

The vehicle 100 includes a body frame 1, a roof 3, pillars 2 attached to the body frame 1 and extending in the top-bottom direction to support the roof 3, a lower electric component 5 located below the pillars 2, an upper electric component 6 located above the pillars 2, and a harness 4 electrically connecting the lower electric component 5 and the upper electric component 6 to each other. In FIG. 1, the harness 4 is indicated by a chain double-dashed line.

The vehicle 100 further includes front seats 11 and rear seats 12. The front seats 11 and the rear seats 12 are supported by the body frame 1. The front seats 11 are individually located at the left and right in the vehicle width direction, and the rear seats 12 are also individually located at the left and right in the vehicle width direction. The front seats 11 are located forward of the rear seats 12. The front seats 11 are located in a front part of a passenger space 8. The rear seats 12 are located in a rear part of the passenger space 8.

The vehicle 100 further includes front wheels 13 and rear wheels 14. The front wheels 13 support a front portion of the body frame 1. The rear wheels 14 support a rear portion of the body frame 1. The front wheels 13 are individually located at the left and right in the vehicle width direction, and the rear wheels 14 are individually located at the left and right in the vehicle width direction. That is, the vehicle 100 is a four-wheeled vehicle.

The vehicle 100 further includes a panel. The panel covers parts supported by the body frame 1. The panel defines an appearance of the vehicle 100. The panel includes a dashboard 7.

The dashboard 7 is attached to the body frame 1. The dashboard 7 is located in the cabin. A steering wheel 15 is located behind the dashboard 7. A driver operates the steering wheel 15 to thereby change the angle of the front wheels 13 to the axle and change the traveling direction of the vehicle 100.

The vehicle 100 further includes a motor 16. The motor 16 is an electric motor that converts electric energy to rotation movement for traveling. The motor 16 is located under the rear seats 12. The motor 16 may be an internal combustion engine, and in this case, the vehicle 100 includes a fuel tank.

The body frame 1 is a portion serving as a framework of a lower portion of the vehicle 100. The body frame 1 is constituted by combining metal pipe parts, metal plate parts, or casted parts, for example. The body frame 1 includes longitudinal frames extending in the front-rear direction and arranged in the vehicle width direction, and lateral frames extending in the vehicle width direction and arranged in the front-rear direction.

The pillars 2 include front pillars 21, center pillars 22, and rear pillars 23. The front pillars 21 will also be referred to as A pillars, the center pillars 22 will also be referred to as B pillars, and the rear pillars 23 will also be referred to as C pillars. When the front pillars 21, the center pillars 22, and the rear pillars 23 are not distinguished from one another, these pillars are referred to simply as “pillars 2.”

Lower portions of the pillars 2 are supported by the body frame 1, and upper portions of the pillars 2 support the roof 3. The pillars 2 are hollow cylinders. A cross section of each of the pillars 2 in a direction orthogonal to the axis thereof is circular. The pillars 2 may be made of a metal or a resin.

The pillars 2 are arranged side by side in the front-rear direction and the left-right direction. Specifically, the front pillars 21, the center pillars 22, and the rear pillars 23 are arranged in this order from the front toward the rear. The front pillars 21 are individually disposed at the left and right in the vehicle width direction. Similarly, the center pillars 22 are individually disposed at the left and right in the vehicle width direction, and the rear pillars 23 are individually disposed at the left and right in the vehicle width direction.

The pillars 2 define the passenger space 8. Specifically, the front pillars 21 and the center pillars 22 define the front part of the passenger space 8. The center pillars 22 and the rear pillars 23 define the rear part of the passenger space 8. The passenger space 8 is open without being obstructed by a wall, an enclosure, or a door so that the passenger can be easily get on and off the vehicle. In this case, the passenger can walk through the passenger space 8 in the left-right direction without being obstructed by a wall, an enclosure, or a door. The passenger space 8 may be obstructed by a wall, an enclosure, or a door. In this case, the enclosure or the door can be opened and closed, and the passenger can get on and off the vehicle by opening the enclosure or the door.

The roof 3 is supported by the front pillars 21, the center pillars 22, and the rear pillars 23. The roof 3 expands in the front-rear direction and the left-right direction to cover the passenger space 8 from above. In the vehicle width direction, the roof 3 extends from the outer side of the left front pillar 21 to the outer side of the right front pillar 21. The roof 3 extends from the outer side of the front pillars 21 to the outer side of the rear pillars 23 in terms of the front-rear direction.

The lower electric component 5 is located near the body frame 1, for example. The lower electric component 5 includes an audio 51, a monitor 52, a battery 53 and a sub-battery 54.

The audio 51 is an acoustic device. The audio 51 is mounted on the dashboard 7. The monitor 52 displays video. The monitor 52 is mounted on the dashboard 7. The battery 53 stores electric energy and supplies electric energy to the electric components and the motor 16. The battery 53 is located under the front seats 11. The sub-battery 54 is located near the lower portion of the front pillars 21. The sub-battery 54 supplies electric power to the monitor 52. The lower electric component 5 may include other accessories such as an amplifier, for example.

The upper electric component 6 is mounted on, for example, the roof 3. The upper electric component 6 includes at least one of loudspeakers 61, a camera 62, an antenna 63, a light 64, or a monitor 65. In this example, the upper electric component 6 includes the loudspeakers 61, the camera 62, and the antenna 63, and does not include the light 64 and the monitor 65. Thus, the light 64 and the monitor 65 are indicated by chain double-dashed lines.

The loudspeakers 61 output sound to the cabin. The loudspeakers 61 include front loudspeakers 61 located above the front cabin part and rear loudspeakers 61 located above the rear cabin part. The front loudspeakers 61 are individually located at the left and right in the vehicle width direction. The rear loudspeakers 61 are individually located at the left and right in the vehicle width direction.

The front loudspeakers 61 are located on the lower surface of a front portion of the roof 3. The front loudspeakers 61 are shifted from the front seats 11 in the front-rear direction. Specifically, the front loudspeakers 61 are located forward of the front seats 11 in terms of the front-rear direction. In this example, the front loudspeakers 61 are located forward of the steering wheel 15 in terms of the front-rear direction.

The rear loudspeakers 61 are located on the lower surface of an intermediate portion of the roof 3. The rear loudspeakers 61 are shifted from the rear seats 12 in the front-rear direction. Specifically, the rear loudspeakers 61 are located forward of the rear seats 12 in terms of the front-rear direction. In this example, the rear loudspeakers 61 are located rearward of the center pillars 22 in terms of the front-rear direction.

The camera 62 captures an image of the rear of the vehicle. The camera 62 is located on the lower surface of a rear end portion of the roof 3. The camera 62 is located on an intermediate portion of the roof 3 in the vehicle width direction. The camera 62 is located outside the passenger space 8 relative to the pillars 2. Specifically, the camera 62 is located rearward of the rear pillars 23 in terms of the front-rear direction.

The antenna 63 is, for example, a radio receiving antenna such as a radio antenna, an external communication antenna such as a GPS or an ETC, or an indoor communication antenna such as Wifi or Bluetooth. The antenna 63 is located on the upper surface of the roof 3.

The light 64 illuminates the cabin. The light 64 is located on the lower surface of the roof 3, for example. The monitor 65 displays video. The monitor 65 is located on the lower surface of the roof 3, for example.

The upper electric component 6 may include, for example, a power supply terminal such as a USB, an actuator that opens and closes a part of the roof 3, or other accessories such as a ventilation fan. The upper electric component 6 may be located on the upper end of the pillar 2 other than the roof 3, for example, the upper electric component 6 may be a light attached to the pillar 2.

The harness 4 includes electric wires. The electric wires include power supply electric wires and signal communication electric wires. The power supply electric wires are connected to the electric components 5 and 6 and the battery 53, and supplies electric energy from the battery 53 to the electric components 5 and 6. The signal communication electric wires are connected between the electric components 5 and 6 and performs signal communication between the electric components 5 and 6. For example, the audio 51 and the loudspeakers 61 are connected to each other so that the loudspeakers 61 output sound of the audio 51. The audio 51 and the antenna 63 are connected to each other so that a signal received by the antenna 63 is transmitted to the audio 51. The monitor 52 and the camera 62 are connected to each other so that the monitor 52 outputs video of the camera 62.

At least a portion of the harness 4 is located in a hollow space inside the pillar 2. At least a portion of the harness 4 passes through the hollow space occupying a half or more of the length of the pillar 2, for example. Specifically, the harness 4 passes through a hollow space of one of the pillars 2 near the lower electric component 5. In this example, the harness 4 passes through a hollow space of the front pillar 21 near the audio 51 and the monitor 52 among the pillars 2. The harness 4 also passes through a hollow space of one of the pillars 2 near the upper electric component 6. In this example, the harness 4 passes a hollow space of the front pillar 21 near the front loudspeakers 61 and the antenna 63 among the pillars 2.

Specifically, the upper electric component 6 and the lower electric component 5 are located near an identical pillar 2 among the pillars 2, and the harness 4 passes through the hollow space of the identical pillar 2. In this example, the forward loudspeakers 61, the antenna 63, the audio 51, and the monitor 52 are located closer to the identical front pillar 21 among the pillars 2, and the harness 4 passes through the hollow space of the identical front pillar 21. The lower electric component 5 is located forward of the passenger space 8, and the harness 4 passes through the hollow space of one of the pillars 2 defining the passenger space 8 and located forward of the passenger space 8. In this example, the audio 51 and the monitor 52 are located forward of the passenger space 8, and the harness 4 passes through the hollow space of the front pillar 2 defining the passenger space 8 and located forward of the passenger space 8 among the pillars 2.

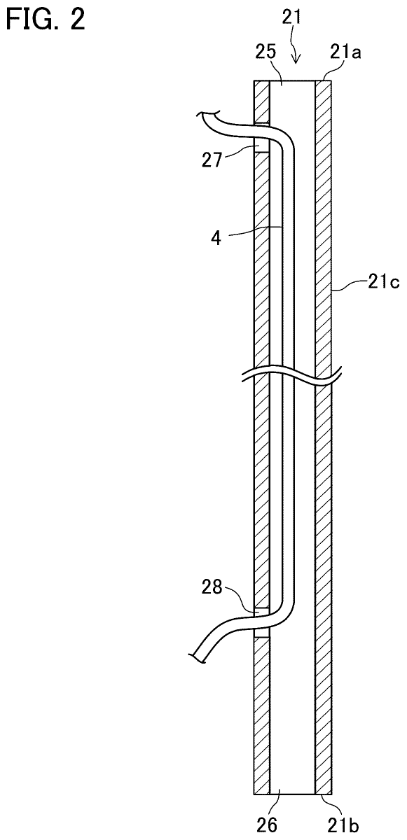

FIG. 2 is a schematic cross-sectional view of the left front pillar 21. Although the left front pillar 21 will be described below, the right front pillar 21 may have the same configuration. The center pillars 22 and the rear pillars 23 may also have the same configuration.

The front pillars 21 have hollow tubular shapes, specifically, hollow cylindrical shapes. That is, the front pillars 21 have hollow spaces. Each of the front pillars 21 includes an upper end hole 25, a lower end hole 26, an upper opening hole 27, and a lower opening hole 28. The upper end hole 25 is open at an upper end 21a of the front pillar 21. The lower end hole 26 is open at a lower end 21b of the front pillar 21. The upper end hole 25 faces the roof 3, and the lower end hole 26 faces the front wheel 13. The upper opening hole 27 and the lower opening hole 28 are open at a side wall 21c of the front pillar 21. The lower opening hole 28 is located below the upper opening hole 27. The upper opening hole 27 is located near the upper end hole 25, and the lower opening hole 28 is located near the lower end hole 26. The upper opening hole 27 and the lower opening hole 28 are circular, but may be other shapes such as an ellipse, an oval, or a polygon. The upper opening hole 27 and the lower opening hole 28 are located on the inner side of the front pillar 21 in the vehicle width direction.

The harness 4 communicates with the inside of the front pillar 21 through the upper opening hole 27 and the lower opening hole 28. Specifically, the harness 4 is routed inside the front pillar 21, a first end of the harness 4 is drawn from the upper opening hole 27 to the outside of the front pillar 21, and a second end of the harness 4 is drawn from the lower opening hole 28 to the outside of the front pillar 21. That is, the harness 4 extends from the upper opening hole 27 and the lower opening hole 28 to the outside of the front pillar 21. Since the upper opening hole 27 and the lower opening hole 28 are located on the inner side in the vehicle width direction, the harness 4 routed on the inner side of the front pillar 21 in the vehicle width direction is near the upper opening hole 27 and the lower opening hole 28 so that the length of the harness 4 can be thereby shortened.

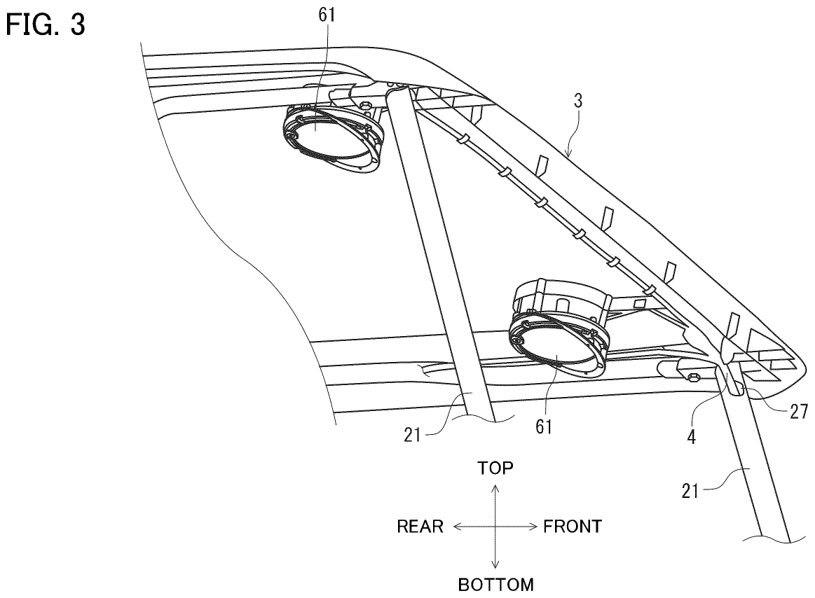

FIG. 3 is a perspective view of the roof 3, as viewed from the front and below. Upper portions of the front pillars 21 are fixed to the lower surface of the roof 3. The loudspeakers 61 are fixed to the lower surface of the roof 3. The harness 4 is drawn from the upper opening holes 27 of the front pillars 21. The harness 4 drawn from the upper opening holes 27 is branched into wires. A first wire of the wires is routed on the lower surface of the roof 3 and connected to the front loudspeakers 61. A second wire of the wires is routed on the lower surface of the roof 3 and connected to the rear loudspeakers 61. A third wire of the wires is routed on the lower surface of the roof 3 and connected to the camera 62. A fourth wire of the wires is routed on the lower surface of the roof 3, penetrates the roof 3 in the top-bottom direction, is drawn to the upper surface of the roof 3, and is connected to the antenna 63.

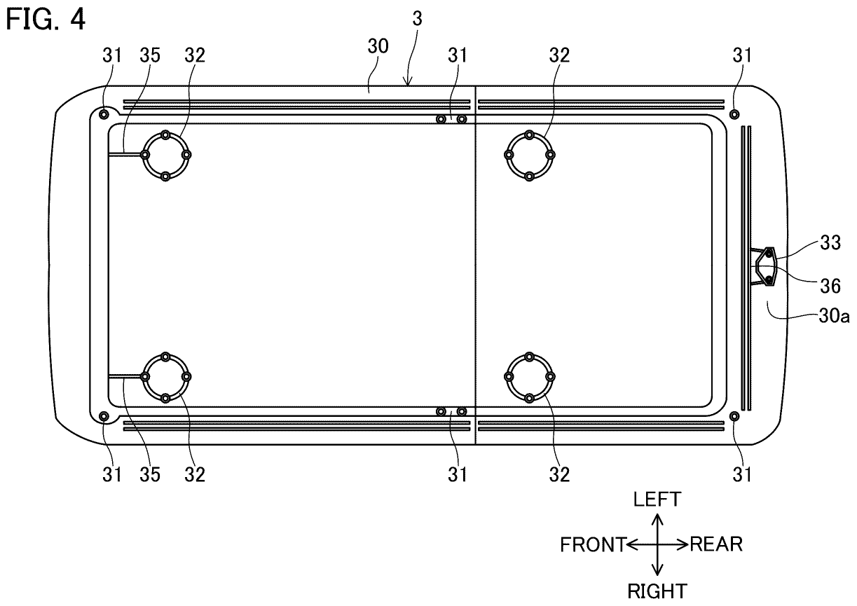

FIG. 4 is a bottom view of the roof 3, as viewed from below. The roof 3 includes a roof body 30, pillar attachment portions 31, loudspeaker attachment portions 32, and a camera attachment portion 33. The pillar attachment portions 31, the loudspeaker attachment portions 32, and the camera attachment portion 33 are located on an identical surface of the roof body 30, specifically, the lower surface of the roof body 30. The roof body 30 is substantially rectangular in a plan view, and the length of the roof body 30 in the front-rear direction is longer than the length of the roof body 30 in the left-right direction.

The pillars 2 are attached to the pillar attachment portions 31. The pillar attachment portions 31 are individually located on a front portion, an intermediate portion, and a rear portion of the roof body 30, and on the left and right in the vehicle width direction. The front pillars 21 are fixed to the front pillar attachment portions 31. The center pillars 22 are fixed to the intermediate pillar attachment portions 31. The rear pillars 23 are fixed to the rear pillar attachment portions 31.

The loudspeakers 61 are attached to the loudspeaker attachment portions 32. The loudspeaker attachment portions 32 are individually located on the front portion and the intermediate portion of the roof body 30, and on the left and right in the vehicle width direction. The front loudspeakers 61 are fixed to the front loudspeaker attachment portions 32, and the rear loudspeakers 61 are fixed to the rear loudspeaker attachment portions 32.

The loudspeaker attachment portions 32 are located near the pillar attachment portions 31. Specifically, the front loudspeaker attachment portions 32 are located near the front pillar attachment portions 31. The expression “near the front pillar attachment portions 31” herein means to be located in a region closer to the front pillar attachment portions 31 than the center between the front and rear pillar attachment portions 31 in terms of the front-rear direction. More preferably, the expression “near the front pillar attachment portions 31” means to be located in a part near the front pillar attachment portions 31 when a region between the forward and rear pillar attachment portions 31 is divided into three parts in terms of the front-rear direction.

The camera 62 is attached to the camera attachment portion 33. The camera attachment portion 33 is located on a rear end portion of the roof body 30 and on the intermediate portion in the vehicle width direction. Specifically, the lower surface of the rear end portion of the roof body 30 includes a slope 30a that is tilted downward toward the rear, and the camera attachment portion 33 is located on the slope 30a.

The camera attachment portion 33 is located rearward of the pillar attachment portions 31. Specifically, the camera attachment portion 33 is located rearward of the rear pillar attachment portions 31 in terms of the front-rear direction.

The roof 3 further includes first restriction portions 35 and a second restriction portion 36. The first restriction portions 35 and he second restriction portion 36 are located on an identical surface of the roof body 30, specifically, the lower surface of the roof body 30.

The first restriction portions 35 and the second restriction portion 36 restrict movement of a portion of the harness 4 extending from the pillars 2 to the upper electric component 6. Specifically, the first restriction portions 35 restrict movement of the wires of the harness 4 extending from the front pillars 21 to the front loudspeakers 61. The second restriction portion 36 restricts movement of the wires included in the harness 4 and extending from the front pillars 21 to the camera 62.

The first restriction portions 35 extend forward from the front loudspeaker attachment portions 32. The first restriction portions 35 are individually located on the left and right in the vehicle width direction. The second restriction portion 36 is located forward of the camera attachment portion 33 in terms of the front-rear direction. The second restriction portion 36 extends in the left-right direction.

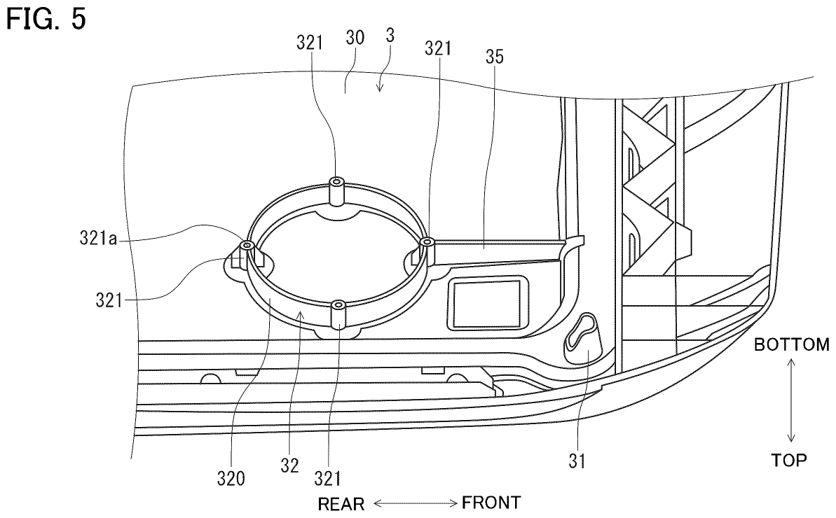

FIG. 5 is a perspective view illustrating the front pillar attachment portion 31, the front loudspeaker attachment portion 32, and the first restriction portion 35, as viewed from below.

The front pillar attachment portion 31 is a tubular body projecting downward from the lower surface of the roof body 30. A peripheral wall of a rear portion of the front pillar attachment portion 31 is cut out. The front pillar attachment portion 31 is inserted into the upper end hole 25 (see FIG. 2) of the front pillar 21 to fix the front pillar 21. The rear pillar attachment portions 31 have a configuration similar to that of the front pillar attachment portions 31. Unlike the front pillar attachment portions 31, the intermediate pillar attachment portions 31 have bolt holes, for example, and bolts for attaching the center pillars 22 are fastened to the bolt holes.

Each of the front loudspeaker attachment portions 32 has an annular base 320 and cylinders 321. In this example, each front loudspeaker attachment portion 32 has four cylinders 321. The base 320 projects downward from the lower surface of the roof body 30. The cylinders 321 are arranged at regular intervals in the circumferential direction of the base 320. Specifically, the cylinders 321 are individually located on a front portion, a rear portion, a left portion, and a right portion of the base 320.

The cylinders 321 are integrated with the base 320. The cylinders 321 project downward from the lower surface of the roof body 30. The cylinders 321 include screw blind holes 321a, and screws for attaching the loudspeakers 61 are fastened to the screw blind holes 321a. The rear loudspeaker attachment portions 32 have a configuration similar to that of the front loudspeaker attachment portions 32.

The first restriction portions 35 are plate walls projecting downward from the lower surface of the roof body 30. The first restriction portions 35 extend in the front-rear direction. The first restriction portions 35 are connected to front portions of the loudspeaker attachment portions 32. Specifically, the first restriction portions 35 are connected to the forward cylinders 321 and extend forward from the forward cylinders 321.

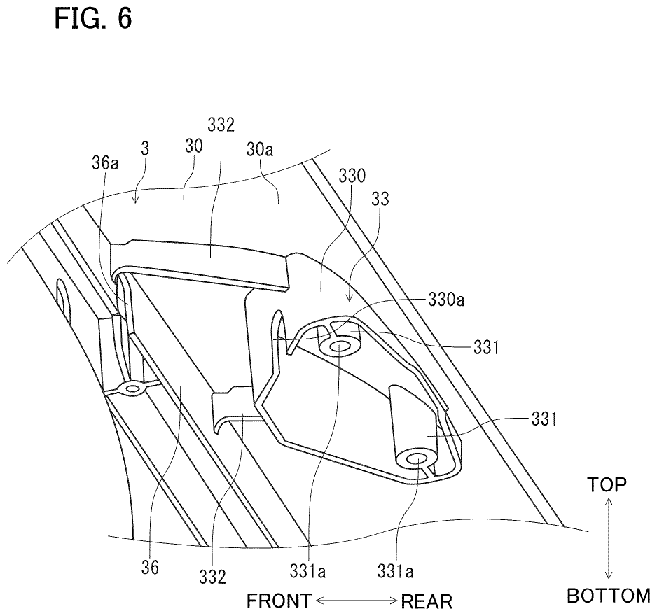

FIG. 6 is a perspective view of the camera attachment portion 33, as viewed from below. The camera attachment portion 33 includes an annular base 330, cylinders 331, and coupling portions 332. In this example, the camera attachment portion 33 includes two cylinders 331 and two coupling portions 332.

The base 330 projects downward from the slope 30a of the roof body 30. A front portion of the base 330 has a cutout 330a cut from below. Into the cutout 330a, a wire included in the harness 4 and connected to the camera 62 is inserted.

The cylinders 331 are located on the inner side of the base 330. The cylinders 331 project downward from the slope 30a of the roof body 30. The two cylinders 331 are arranged side by side in the left-right direction. The cylinders 331 include screw blind holes 331a, and screws for attaching the camera 62 are fastened to the screw blind holes 331a.

The coupling portions 332 project downward from the slope 30a of the roof body 30. Each of the coupling portions 332 extends in the front-rear direction. Each coupling portion 332 is located between the base 330 and the second restriction portion 36, and coupled to the base 330 and the second restriction portion 36. The two coupling portions 332 are arranged side by side in the left-right direction. The cutout 330a is located in a region between the two coupling portions 332 in terms of the left-right direction.

The second restriction portion 36 projects downward from the lower surface of the roof body 30. The second restriction portion 36 extends in the left-right direction. The second restriction portion 36 is connected to a front portion of the camera attachment portion 33. Specifically, the second restriction portion 36 is connected to front portions of the coupling portions 332.

The second restriction portion 36 has a cutout 36a cut from below. Into the cutout 36a, the wire included in the harness 4 and connected to the camera 62 is inserted. The cutout 36a is located in a region between the two coupling portions 332 in terms of the front-rear direction.

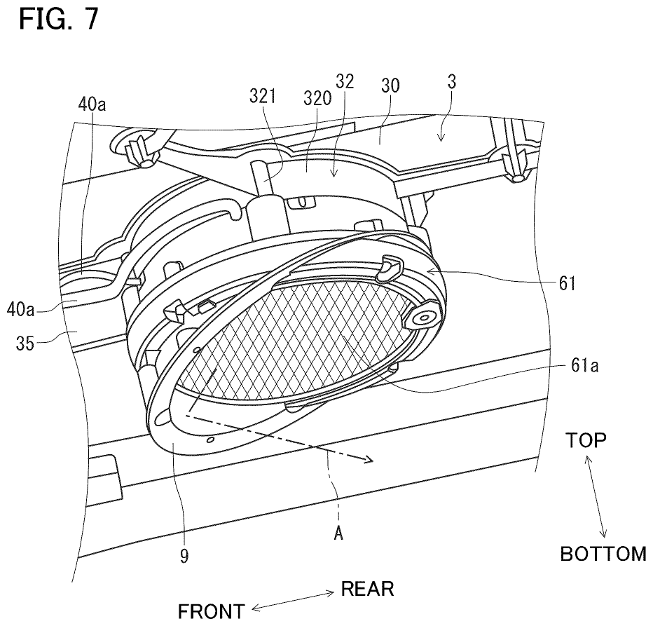

FIG. 7 is a perspective view of the forward loudspeaker 61 attached to the roof 3, as viewed from below. The loudspeaker 61 is fixed to the loudspeaker attachment portion 32 of the roof 3.

Specifically, the loudspeaker 61 is mounted on the base 320 of the loudspeaker attachment portion 32. Screws attached to the loudspeaker 61 are fastened to the screw blind holes 321a (see FIG. 5) of the cylinder 321 of the loudspeaker attachment portion 32 so that the loudspeaker 61 is thereby fixed to the cylinder 321.

A wire 40a included in the harness 4 and connected to the loudspeaker 61 is routed along the first restriction portion 35. The first restriction portion 35 restricts movement of the wire 40a. Specifically, the first restriction portion 35 restricts movement of the wire 40a to one side in the left-right direction.

A reflector 9 is attached to the loudspeaker 61. The reflector 9 is attached to the loudspeaker 61 in a flange shape. The reflector 9 is located downstream of a sound emitting surface 61a of the loudspeaker 61 in a sound emitting direction and adjacent to the sound emitting surface 61a to reflect sound traveling away from the front seats 11. Specifically, the reflector 9 is located forward of the loudspeaker 61 and extends downward from the sound emitting surface 61a. The reflector 9 surrounds a front portion of the sound emitting surface 61a. The lower end of the reflector 9 tilts upward such that the distance from the sound emitting surface 61a decreases from the front to the rear. That is, the height of the reflector 9 decreases from the front to the rear. Accordingly, as indicated by broken arrow A, the reflector 9 reflects sound radiated forward from the sound emitting surface 61a rearward. That is, the reflector 9 reflects sound traveling away from the front seats 11 toward the front seats 11. In a case where the front seats 11 includes headrests, the reflector 9 is located forward of the headrests in terms of the front-rear direction. At this time, the reflector 9 emits sound at an angle toward the head of the passenger. This allows the passenger to more easily perceive high-frequency sound.

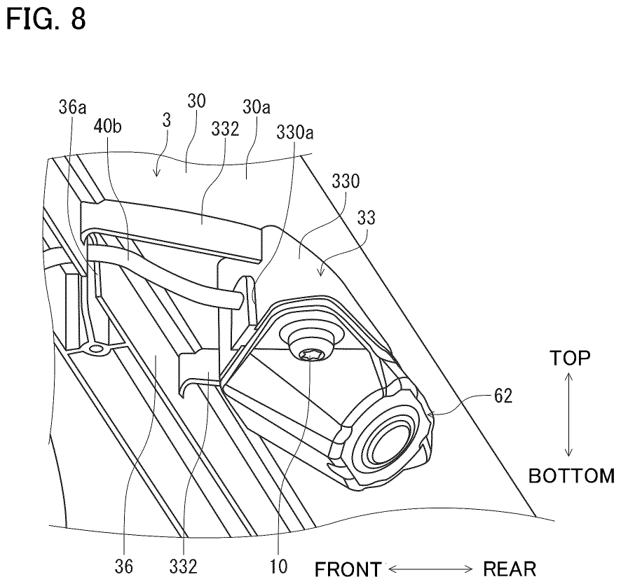

FIG. 8 is a perspective view of the camera 62 attached to the roof 3, as viewed from below. The camera 62 is fixed to the camera attachment portion 33 of the roof 3. That is, the camera 62 is located on the slope 30a.

Specifically, the camera 62 is mounted on the base 330 of the camera attachment portion 33. Screws 10 attached to the camera 62 is fastened to the screw blind holes 331a (see FIG. 6) of the cylinder 331 of the camera attachment portion 33 so that the camera 62 is thereby fixed to the cylinder 331.

A wire 40b included in the harness 4 and connected to the camera 62 is inserted into the cutout 330a of the base 330 of the camera attachment portion 33, and is located in a region between the two coupling portions 332 of the camera attachment portion 33. The wire 40b is inserted into the cutout 36a of the second restriction portion 36, and the second restriction portion 36 restricts movement of the wire 40b. Specifically, the second restriction portion 36 restricts movement of the wire 40b in the left-right direction.

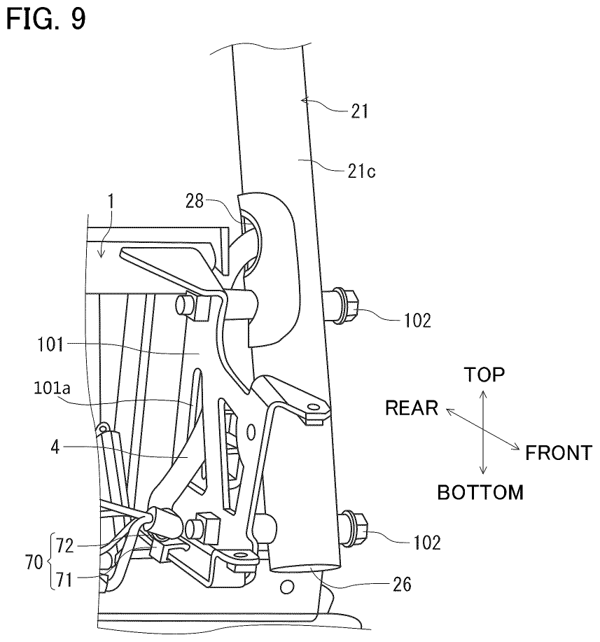

FIG. 9 is a perspective view of a state where the left front pillar 32 is attached to the body frame 1, as viewed from the front and above.

A lower portion of the front pillar 21 is fixed to the body frame 1 by two bolts 102. Specifically, the bolts 102 penetrate the side wall 21c of the front pillar 21 and fix the front pillar 21 to an attachment plate 101 of the body frame 1. The two bolts 102 are located below the lower opening hole 28 of the front pillar 21.

The lower opening hole 28 is open on the inner side in the vehicle width direction. The harness 4 is drawn from the lower opening hole 28. The harness 4 drawn from the lower opening hole 28 is routed along the attachment plate 101. The attachment plate 101 includes a hole 101a, and the harness 4 passes through the hole 101a. Movement of the harness 4 is restricted by the hole 101a.

Movement of the harness 4 is restricted by a restrictor 70. The restrictor 70 is adjacent to the lower opening hole 28. Specifically, the restrictor 70 is located below the lower opening hole 28. The restrictor 70 is detachably attached to the attachment plate 101.

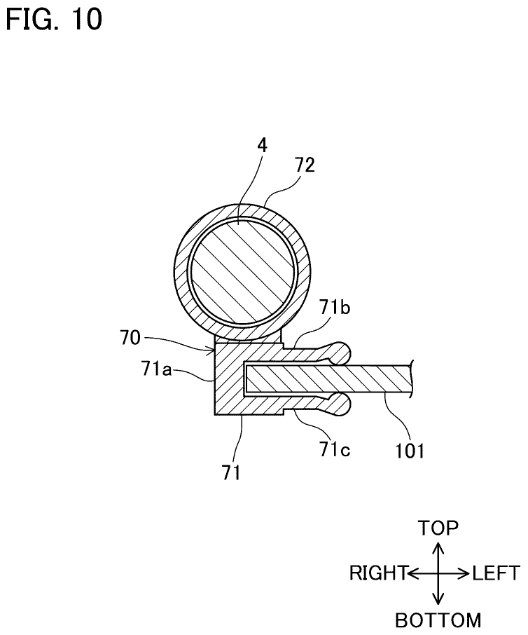

FIG. 10 is a schematic cross-sectional view of the restrictor 70 that restricts movement of the harness 4. FIG. 10 shows a simplified cross section of the harness 4.

The restrictor 70 includes a clip 71, and a ring 72 fixed to the clip 71. The harness 4 penetrates the ring 72 to be held by the ring 72. The clip 71 is detachably attached to the rim of the attachment plate 101.

The clip 71 includes a base 71a, a first plate 71b attached to a first end portion of the base 71a, and a second plate 71c attached to a second end portion of the base 71a. The first plate 71b and the second plate 71c face each other. The first plate 71b and the second plate 71c are elastically deformed to move toward or away from each other. The first plate 71b and the second plate 71c sandwich and hold the attachment plate 101 while applying an elastic force to the attachment plate 101. The clip 71 can be detached from the attachment plate 101 by separating the first plate 71b and the second plate 71c from each other against an elastic force.

In the vehicle 100 described above, at least a portion of the harness 4 is located in the hollow space of the pillar 2, the structure for supporting the harness 4 can be simplified as compared to a case where the harness 4 extends outside the pillar 2 in the top-bottom direction.

Since the upper electric component 6 is located on the roof 3, the structure for supporting the harness 4 extending in the vehicle top-bottom direction can be simplified.

Since the harness 4 passes through the hollow space of the pillar 2 included in the pillars 2 and located near the lower electric component 5, the length of the harness 4 can be shortened as compared to a case where the harness 4 passes through other pillars 2.

Since the harness 4 passes through the hollow space of the pillar 2 included in the pillars 2 and located near the upper electric component 6, the length of the harness 4 can be shortened as compared to a case where the harness 4 passes through other pillars 2.

Since the harness 4 passes through the hollow space of the pillar 2 included in the pillars 2 and located near the upper electric component 6 and the lower electric component 5, the length of the harness 4 can be shortened as compared to a case where the harness 4 passes through other pillars 2.

Since the harness 4 passes through the hollow space of the pillar 2 included in the pillars 2, defining the passenger space 8, and located forward of the passenger space 8, the length of the harness 4 can be shortened as compared to the case where the harness 4 passes through other pillars 2.

The roof 3 includes the restriction portions 35 and 36 that restrict movement of a portion included in the harness 4 and extending from the pillar 2 to the upper electric component 6, and thus, a new restrictor is not necessary or simplified, and movement of the harness 4 can be easily prevented.

The vehicle 100 includes the restrictor 70 that is adjacent to the lower opening hole 28 of the pillar 2 and restricts movement of the harness 4. Thus, movement of the harness 4 near the lower opening hole 28 can be suppressed.

The upper electric component 6 includes at least one of the loudspeakers 61, the camera 62, the antenna 63, the light 64, or the monitor 65, and thus, can be used for various types of electric components.

The loudspeakers 61 are shifted from the seats 11 and 12 in the front-rear direction, and thus, can prevent interference of the loudspeakers 61 projecting downward from the roof 3 with the passenger when the passenger gets on and off the vehicle.

Since the vehicle 100 includes the reflector 9, the volume of sound traveling toward the front seats 11 can be increased so that a decrease in the volume of sound that the passenger senses can be prevented.

The upper electric component 6 is the camera 62, and thus, the camera 62 is mounted on the roof 3 to capture an image from a high position.

The camera 62 is located outside the passenger space 8 relative to the pillars 2, and thus, it is possible to prevent the pillars 2 from appearing in the imaging region of the camera 62. Even when the space between the adjacent pillars 2 is closed by the enclosure, it is possible to prevent the enclosure from closing the imaging region of the camera 62.

The camera 62 is located on the slope 30a of the lower surface of a rear end portion of the roof 3. Thus, even when the field of view of the camera 62 is wide, it is possible to prevent the slope 30a of the roof 3 from appearing in the image of the camera 62. In addition, the field of view of the camera 62 is easily directed downward.

The camera 62 is located on the rear end portion of the roof 3. Thus, the camera 62 can capture an image of the rear side, and it is easy to assist driving for rearward movement.

In the roof 3 described above, the loudspeaker attachment portions 32 are located near the pillar attachment portions 31. Thus, in a case where the roof 3 is used for a vehicle, the loudspeakers 61 are attached to the loudspeaker attachment portions 32, and the pillars 2 are attached to the pillar attachment portions 31, the loudspeakers 61 are less likely to hinder the passenger from getting on and off, and the harness 4 is easily routed along the pillars 2 to extend in the top-bottom direction.

The camera attachment portion 33 is located rearward of the pillar attachment portions 31. Thus, in a case where the roof 3 is used for a vehicle, the camera 62 is attached to the camera attachment portion 33, and the pillars 2 are attached to the pillar attachment portions 31, the camera 62 can capture an image from a high position, and interference between the pillars 2 and the camera 62 can be easily prevented.

### First Variation

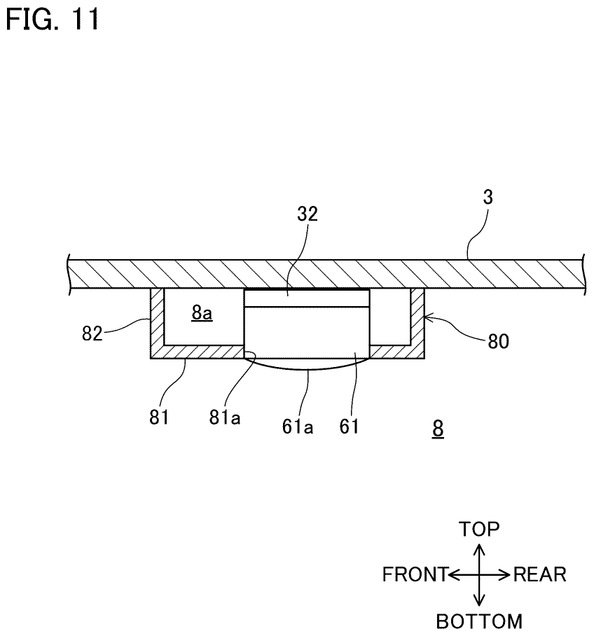

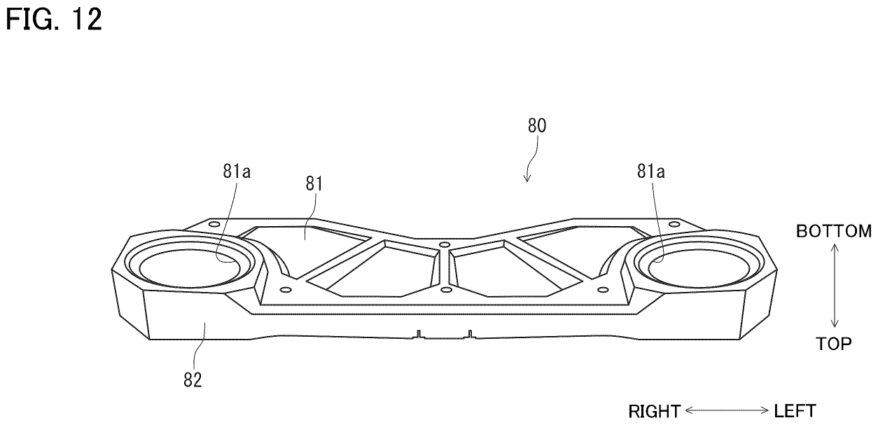

FIG. 11 is a cross-sectional view including a front loudspeaker 61 and a roof 3 of a vehicle (an example of a vehicle) according to the first variation. FIG. 12 is a perspective view of a cover 80. The vehicle according to the first variation is different from the vehicle 100 according to the embodiment in including the cover 80. The following description will be directed mainly to a part of the configuration of the vehicle according to the first variation different from the vehicle 100 according to the embodiment. In the vehicle according to the first variation, the same reference characters as those of the vehicle 100 according to the embodiment denote the same components as those of the vehicle 100 according to the embodiment, and thus, description thereof will be omitted.

The vehicle according to the first variation further includes the cover 80. The cover 80 is fixed to the roof 3 so that the cover 80 and the roof 3 thereby define a closed space 8a that is closed with respect to a passenger space 8. The cover 80 causes at least a portion of a casing of the loudspeaker 61 except for a sound emitting surface 61a to be accommodated in the closed space 8a.

Specifically, the cover 80 has a box shape, and includes a bottom wall 81 and a side wall 82 located at the periphery of the bottom wall 81. An inner space surrounded by the bottom wall 81 and the side wall 82 corresponds to the closed space 8a. The bottom wall 81 has two holes 81a. The two holes 81a are arranged side by side in the left-right direction. The size of the holes 81a corresponds to the size of a sound emitting surface 61a of the loudspeaker 61.

The cover 80 is fixed to the lower surface of the roof 3 with, for example, screws. The cover 80 covers at least a part of the casing of the loudspeaker 61 except for the sound emitting surface 61a by the bottom wall 81 and the side wall 82. The cover 80 exposes the sound emitting surfaces 61a of the loudspeakers 61 from the holes 81a. The cover 80 integrally covers the left and right loudspeakers 61.

The cover 80 may cover the left and right loudspeakers 61 separately. The cover 80 may be located to cover the rear loudspeakers 61.

In the vehicle according to the first variation, the cover 80 causes at least a portion of the casing of the loudspeaker 61 except for the sound emitting surface 61a to be accommodated in the closed space 8a. Thus, it is possible to prevent antiphase sound emitted from the side opposite to the sound emitting surface 61a of the loudspeaker 61 from traveling to the passenger space 8. This can suppress canceling of sound emitted from the sound emitting surface 61a to thereby enable emission of intended sound.

The description of other configurations, operations, and effects will be omitted, but the description of the vehicle 100 according to the embodiment can be used for the description of the vehicle according to the first variation.

### Other Embodiments

In the foregoing section, the embodiment has been described as an example of the technique disclosed in the present application. The technique disclosed here, however, is not limited to this embodiment, and is applicable to other embodiments obtained by changes, replacements, additions, and/or omissions as necessary. Components described in the above embodiment may be combined as a new exemplary embodiment. Components provided in the accompanying drawings and the detailed description can include components unnecessary for solving problems as well as components necessary for solving problems in order to exemplify the technique. Therefore, it should not be concluded that such unnecessary components are necessary only because these unnecessary components are included in the accompanying drawings or the detailed description.

The vehicle 100 may be a single-passenger vehicle. The vehicle 100 may include only one seat or three or more seat in the front-rear direction. The vehicle 100 may also be a three-wheeled vehicle having three wheels, or may be a six-wheeled vehicle having six wheels.

The number of the pillars 2 may be increased or reduced. Although the pillars 2 include the front pillars 21, the center pillars 22, and the rear pillars 23, but the center pillars 22 may be omitted.

The cross section of the front pillars 21 is circular, but may be other shapes such as an oval or a polygon. The same holds for the center pillars 22 and the rear pillars 23.

Although the harness 4 passes through the hollow space of the front pillar 21, the harness 4 may pass through the hollow space of the center pillar 22 or the rear pillar 23.

The harness 4 may pass through the hollow space of the pillar 2 included in the pillars 2 and located away from the lower electric component 5. The harness 4 may pass through the hollow space of the pillar 2 included in the pillars 2 and located away from the upper electric component 6.

Multiple harnesses 4 may be provided. The upper electric component 6 and the lower electric component 5 may be located near different pillars 2 among the pillars 2, and the harnesses 4 may pass through hollow spaces of the different pillars 2.

The lower electric component 5 may be located rearward of the passenger space 8, and the harness 4 may pass through the hollow space of the pillar 2 included in the pillars 2, defining the passenger space 8, and located rearward of the passenger space 8.

The loudspeakers 61 may be located at positions overlapping the seats in the front-rear direction. Specifically, the front loudspeakers 61 may be located at positions overlapping the front seats 11 in the front-rear direction. The rear loudspeakers 61 may be located at positions overlapping the rear seats 11 in the front-rear direction.

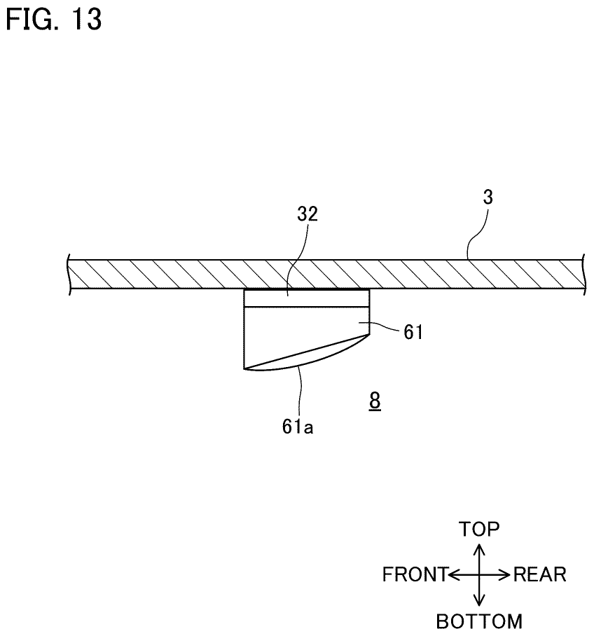

The reflector 9 is used for the front loudspeakers 61, but may be used for at least one of the front loudspeakers 61 or the rear loudspeakers 61. Alternatively, the reflector 9 may be omitted. In this case, as illustrated in FIG. 13, the sound emitting surface 61a of the front loudspeaker 61 may be tilted relative to the horizontal plane to face the front seats 11. Specifically, the sound emitting surface 61a may be tilted relative to the horizontal plane such that front portion of the sound emitting surface 61a is located below a rear portion of the sound emitting surface 61a. Accordingly, the sound emitting surface 61a emits sound at an angle toward the front seats 11. This allows the passenger to easily perceive high-frequency sound. Similarly, the sound emitting surface 61a of the rear loudspeaker 61 may be tilted relative to the horizontal plane to face the rear seats 12. It should be noted that the reflector 9 may be used in FIG. 13.

The camera 62 may be mounted on a front end portion of the roof 3. The camera 62 may be located inside the passenger space 8 relative to the pillars 2.

The roof 3 includes the first restriction portions 35 and the second restriction portion 36, but may include one of the first restriction portions 35 or the second restriction portion 36. Alternatively, the roof 3 may not include any of the first restriction portions 35 and the second restriction portion 36.

The roof 3 may include the pillar attachment portions 31, the loudspeaker attachment portions 32, and the camera attachment portion 33, but may include the pillar attachment portions 31 and the loudspeaker attachment portions 32 without the camera attachment portion 33. Alternatively, the roof 3 may include the pillar attachment portions 31 and the camera attachment portion 33 without the loudspeaker attachment portions 32.

The restrictor 70 includes the clip 71 and the ring 72, but may be a part of the body frame 1 or may be a resin material such as a tape. Alternatively, the restrictor 70 may be omitted.

The vehicle of the present disclosure may be an off-road vehicle or an on-road vehicle. Examples of the off-road vehicle include a utility vehicle, a side-by-side vehicle, and a tractor.

### Aspects

The embodiments described above are specific examples of the following aspects.

(Aspect 1)

A vehicle (utility vehicle 100) includes: a roof 3; a hollow pillar 2 extending in a top-bottom direction and supporting the roof 3; a lower electric component 5 located below the pillar 2; an upper electric component 6 located above the pillar 2; and a harness 4 electrically connecting the lower electric component 5 and the upper electric component 6 to each other and at least partially located in a hollow space inside the pillar 2.

In this configuration, the structure for supporting the harness 4 can be simplified as compared to a case where the harness 4 extends outside the pillar 2 in the top-bottom direction.

(Aspect 2)

In the vehicle of Aspect 1, the upper electric component 6 is mounted on the roof 3.

This configuration can simplify the structure for supporting the harness 4 elongated and extending in the vehicle top-bottom direction.

(Aspect 3)

In the vehicle of Aspect 1 or 2,
the pillar 2 includes a plurality of pillars 2 arranged in a front-rear direction and a left-right direction, and
the harness 4 passes through the hollow space of the pillar 2 included in the pillars 2 and located near the lower electric component 5.

This configuration can shorten the length of the harness 4 as compared to a case where the harness 4 passes through other pillars 2.

(Aspect 4)

In the vehicle of any one of Aspects 1 to 3,
the pillar 2 includes a plurality of pillars 2 arranged in a front-rear direction and a left-right direction, and
the harness 4 passes through the hollow space of the pillar 2 included in the pillars 2 and located near the upper electric component 6.

This configuration can shorten the length of the harness 4 as compared to a case where the harness 4 passes through other pillars 2.

(Aspect 5)

In the vehicle of any one of Aspects 1 to 4,
the pillar 2 includes a plurality of pillars 2 arranged in a front-rear direction and a left-right direction,
the upper electric component 6 and the lower electric component 5 are located near an identical pillar 2 among the pillars 2, and
the harness 4 passes through the hollow space of the identical pillar 2.

This configuration can shorten the length of the harness 4 as compared to a case where the harness 4 passes through other pillars 2.

(aspect 6)

In the vehicle of any one of Aspects 1 to 5, further includes
the pillar 2 includes a plurality of pillars 2 arranged in a front-rear direction and a left-right direction,
the lower electric component 5 is located forward of a passenger space 8, and
the harness 4 passes through the hollow space of the pillar included in the pillars 2, defining the passenger space 8, and located forward of the passenger space 8.

This configuration can shorten the length of the harness 4 as compared to a case where the harness 4 passes through other pillars 2.

(Aspect 7)

The vehicle of any one of Aspects 1 to 6 further includes:
the roof 3 includes a restriction portion 35, 36 that restricts movement of a portion included in the harness 4 and extending from the pillar 2 to the upper electric component 6.

This configuration can eliminate or simplify a new restrictor, and movement of the harness 4 is easily prevented.

(Aspect 8)

The vehicle of any one of Aspects 1 to 7,
a lower portion of the pillar 2 has a lower opening hole 28 through which the harness 4 extends to outside of the pillar 2, and
the vehicle further includes a restrictor 70 that is located adjacent to the lower opening hole 28 and that restricts movement of the harness 4.

This configuration can suppress movement of the harness 4 near the lower opening hole 28.

(Aspect 9)

In the vehicle of any one of Aspects 1 to 8,
the upper electric component 6 includes at least one of a loudspeaker 61, a camera 62, an antenna 63, a light 64, and a monitor 65.

This configuration can cope with multiple types of electric components.

(Aspect 10)

The vehicle of any one of Aspects 1 to 9 further includes
a cover 80 that is fixed to the roof 3 such that the cover 80 and the roof 3 define a closed space 8a, the closed space 8a being closed with respect to the passenger space 8,
the upper electric component 6 is a loudspeaker, and
the cover 80 causes at least a portion of a casing of the loudspeaker 61 except for a sound emitting surface 61a to be accommodated in the closed space 8a.

This configuration can suppress canceling of sound emitted from the sound emitting surface 61a to thereby enable emission of intended sound.

(Aspect 11)

The vehicle of any one of Aspects 1 to 10 further includes
a seat 11,
the upper electric component 6 is a loudspeaker 61, and
the loudspeaker 61 is shifted from the seat 11 in a front-rear direction.

This configuration can prevent interference of the loudspeaker 61 projecting downward from the roof 3 with a passenger when the passenger gets on and off the vehicle.

(Aspect 12)

The vehicle of any one of Aspects 1 to 11 further includes
a seat 11,
the upper electric component 6 is a loudspeaker 61, and
the vehicle further includes a reflector 9 that is located downstream of a sound emitting surface 61a of the loudspeaker 61 in a sound emitting direction and adjacent to the sound emitting surface 61a to reflect sound traveling away from the seat 11.

This configuration can increase the volume of sound traveling toward the seat 11 so that a decrease in volume of sound that the passenger senses can be prevented.

(Aspect 13)

The vehicle of any one of Aspects 1 to 12 further includes
a seat 11,
the upper electric component 6 is a loudspeaker 61,
the loudspeaker 61 is shifted from the seat 11 in a front-rear direction, and
the vehicle further includes a reflector 9 that is located downstream of a sound emitting surface 61a of the loudspeaker 61 in a sound emitting direction and adjacent to the sound emitting surface 61a to reflect sound traveling away from the seat 11.

This configuration can prevent interference of the loudspeaker 61 projecting downward from the roof 3 with a passenger when the passenger gets on and off the vehicle, and a decrease in volume of sound that the passenger can sense can be prevented.

(Aspect 14)

In the vehicle of any one of Aspects 1 to 13,
the upper electric component 6 is a camera 62.

In this configuration, the camera 62 is mounted on the roof 3 so that the camera 62 can capture an image from a high position.

(Aspect 15)

In the vehicle of any one of Aspects 1 to 14,
the pillar 2 includes a plurality of pillars 2 arranged in a front-rear direction and a left-right direction,
the upper electric component 6 is a camera 62, and
the camera 62 is located outside the passenger space 8 relative to the pillars 2.

This configuration can prevent the pillars 2 from appearing in an imaging region of the camera 62, and also prevent an enclosure located between adjacent pillars 2 from closing the imaging region of the camera 62.

(Aspect 16)

In the vehicle of any one of Aspects 1 to 15,
the upper electric component 6 is a camera 62, and
a lower surface of a rear end portion of the roof 3 includes a slope 30a that is tilted downward toward rear, and
the camera 62 is mounted on the slope 30a.

This configuration can prevent the slope 30a of the roof 3 from appearing in an image of the camera 62 even in a case where the field of view of the camera 62 is wide.

(Aspect 17)

In the vehicle of any one of Aspects 1 to 16,
the upper electric component 6 is a camera 62, and
the camera 62 is mounted on a rear end portion of the roof 3.

In this configuration, the camera 62 can capture an image of the rear side, and it is easy to assist driving for rearward movement.

(Aspect 18)

A roof 3 includes: a roof body 30; and a pillar attachment portion 31 and a loudspeaker attachment portion 32 located on an identical surface of the roof body 30, and the loudspeaker attachment portion 32 is located near the pillar attachment portion 31.

In this configuration, in a case where the roof 3 is used for a vehicle, the loudspeaker 61 is attached to the loudspeaker attachment portion 32, and the pillar 2 is attached to the pillar attachment portion 31, the loudspeaker 61 is less likely to hinder the passenger from getting on and off, and the harness 4 is easily routed along the pillar 2 to extend in the top-bottom direction.

(Aspect 19)

A roof 3 includes: a roof body 30; and a pillar attachment portion 31 and a camera attachment portion 33 located on an identical surface of the roof body 30, and the camera attachment portion 33 is located rearward of the pillar attachment portion 31.

In this configuration, in a case where the roof 3 is used for a vehicle, the camera 62 is attached to the camera attachment portion 33, and the pillar 2 is attached to the pillar attachment portion 31, the camera 62 can capture an image from a high position, and interference between the pillar 2 and the camera 62 can be easily prevented.

What is claimed:

1. A vehicle comprising:
a roof;
a hollow pillar extending in a top-bottom direction and supporting the roof;
a lower electric component located below the pillar;
an upper electric component located above the pillar; and
a harness electrically connecting the lower electric component and the upper electric component to each other and at least partially located in a hollow space inside the pillar.

2. The vehicle according to claim 1, wherein
the upper electric component is mounted on the roof.

3. The vehicle according to claim 1, wherein
the pillar comprises a plurality of pillars arranged in a front-rear direction and a left-right direction, and
the harness passes through the hollow space of the pillar included in the pillars and located near the lower electric component.

4. The vehicle according to claim 1, wherein
the pillar comprises a plurality of pillars arranged in a front-rear direction and a left-right direction, and
the harness passes through the hollow space of the pillar included in the pillars and located near the upper electric component.

5. The vehicle according to claim 1, wherein
the pillar comprises a plurality of pillars arranged in a front-rear direction and a left-right direction,
the upper electric component and the lower electric component are located near an identical pillar among the pillars, and
the harness passes through the hollow space of the identical pillar.

6. The vehicle according to claim 1, wherein
the pillar comprises a plurality of pillars arranged in a front-rear direction and a left-right direction,
the lower electric component is located forward of a passenger space, and
the harness passes through the hollow space of the pillar included in the pillars, defining the passenger space, and located forward of the passenger space.

7. The vehicle according to claim 2, wherein
the roof includes a restriction portion that restricts movement of a portion included in the harness and extending from the pillar to the upper electric component.

8. The vehicle according to claim 1, wherein
a lower portion of the pillar has a lower opening hole through which the harness extends to outside of the pillar, and
the vehicle further comprises a restrictor that is located adjacent to the lower opening hole and that restricts movement of the harness.

9. The vehicle according to claim 2, wherein
the upper electric component includes at least one of a loudspeaker, a camera, an antenna, a light, or a monitor.

10. The vehicle according to claim 2, further comprising
a cover that is fixed to the roof such that the cover and the roof define a closed space, the closed space being closed with respect to a passenger space, wherein
the upper electric component is a loudspeaker, and
the cover causes at least a portion of a casing of the loudspeaker except for a sound emitting surface to be accommodated in the closed space.

11. The vehicle according to claim 2, further comprising
a seat, wherein
the upper electric component is a loudspeaker, and
the loudspeaker is shifted from the seat in a front-rear direction.

12. The vehicle according to claim 2, further comprising
a seat, wherein
the upper electric component is a loudspeaker, and
the vehicle further comprises a reflector that is located downstream of a sound emitting surface of the loudspeaker in a sound emitting direction and adjacent to the sound emitting surface to reflect sound traveling away from the seat.

13. The vehicle according to claim 2, further comprising
a seat, wherein
the upper electric component is a loudspeaker,
the loudspeaker is shifted from the seat in a front-rear direction, and
the vehicle further comprises a reflector that is located downstream of a sound emitting surface of the loudspeaker in a sound emitting direction and adjacent to the sound emitting surface to reflect sound traveling away from the seat.

14. The vehicle according to claim 2, wherein
the upper electric component is a camera.

15. The vehicle according to claim 2, wherein
the pillar comprises a plurality of pillars arranged in a front-rear direction and a left-right direction,
the upper electric component is a camera, and
the camera is located outside a passenger space relative to the pillars.

16. The vehicle according to claim 2, wherein
the upper electric component is a camera,
a lower surface of a rear end portion of the roof includes a slope that is tilted downward toward rear, and
the camera is mounted on the slope.

17. The vehicle according to claim 2, wherein
the upper electric component is a camera, and
the camera is mounted on a rear end portion of the roof.

18. A roof comprising:
a roof body; and
a pillar attachment portion and a loudspeaker attachment located on an identical surface of the roof body, wherein
the loudspeaker attachment portion is located near the pillar attachment portion.

19. A roof comprising:
a roof body; and
a pillar attachment portion and a camera attachment portion located on an identical surface of the roof body, wherein
the camera attachment portion is located rearward of the pillar attachment portion.
